(19) United States
(12) Patent Application Publication
(10) Pub. No.: US 2010/0144372 A1
(43) Pub. Date: Jun. 10, 2010

(54) SYSTEM FOR TELECOMMUNICATION

(76) Inventor: Sytze Jacob Bouwer, Leeuwarden (NL)

Correspondence Address: MEDLEN & CARROLL, LLP, 101 HOWARD STREET, SUITE 350, SAN FRANCISCO, CA, 94105, US

(21) Appl. No.: 12/449,183

(22) PCT Filed: Jan. 29, 2008
(86) PCT No.: PCT/NL2008/000030

§ 371 Date: Feb. 9, 2010

(30) Foreign Application Priority Data
Jan. 29, 2007 (NL) 1033296

(51) Int. Cl. H04W 64/00; H04W 4/12; G06Q 30/00; G01C 21/00; G01C 21/36

(52) U.S. Cl. 455/456.3; 455/466; 705/14.58; 705/14.1; 705/14.54; 701/300; 701/211

(57) ABSTRACT

The invention relates to a system for telecommunication, comprising:—a wireless network for telecommunication with at least one transmitter/receiver, which network is provided with message facilities such as SMS and MMS and the like; and—at least one portable communication device connected to or to be connected to the network and having means for at least receiving messages. The network comprises means for determining the position of the communication device in or close to an establishment, and a transmitter for sending a message to the communication device in character with the establishment.

The present invention relates to a system for telecommunication comprising a wireless network for telecommunication with at least one transmitter/receiver, which network is provided with message facilities such as SMS and MMS and the like. The system further comprises at least one portable communication device connected to or to be connected to the network and having means for at least receiving messages.

Means are provided in the network for determining the position of the communication device in or close to an establishment.

The GSM network, within which it is currently possible to determine the exact position or location of individual GSM devices or telephones, is only mentioned by way of example. A very high degree of accuracy can here already be achieved, this for instance being used in emergency situations. When the owner of such a communication device must be located, position determination relating to the communication device of this owner can be carried out in the network. The owner can be located on the basis hereof, even if he or she is unable at any moment to answer the telephone, which may be an embodiment of a communication device.

Such a technique does not per se have any drawbacks.

It can be difficult for shoppers to enter an establishment, for instance in order to make a hurried purchase. People are then usually dependent on good signposting, and are often only aware of offers through placing of individual displays in the establishment for the purpose of attracting attention to the offers in a special way. The drawback remains that it is difficult for a visitor to a shop, as possible embodiment of an establishment according to the present invention, to find the way quickly in a shop or other establishment, particularly when this person is not familiar with the establishment in question.

The present invention has for its object to make it easier for shoppers to find their way in an establishment, in particular a shop, on the basis of equipment which is finding increasingly wide application and which almost everyone carries. A portable telephone is stated as an example hereof, although the invention is of course not limited thereto when the term communication devices is used. This is because many other possible embodiments also fall into this category, such as a PDA, a laptop with wireless network options, a smart phone, etc. The present invention is distinguished from the known techniques in that the network comprises means for determining the position of the communication device in or close to an establishment, and further comprises a transmitter for sending a message to the communication device in character with the establishment, in particular a commercial message. The owner of a communication device is thus made aware in new and inventive manner of offers or the location of products or objects in or close to the establishment. Depending on the accuracy of the position determination, and the possibilities of following the owner of the communication device through the establishment, the owner of the communication device can even be guided to a selected product in the establishment. This however requires only a sequence of position determinations and a clever control for the purpose of distilling directions and movements therefrom.

The owner of the communication device can in any case be made aware of offers, and the location where products and the like are arranged, in that the vicinity of the communication device is detected by the network and/or the location of the device within the network is determined, depending on the extent of the network, and the owner is then sent a message which he or she can receive on his/her communication device, on the basis of which commercial messages can be communicated. Even dynamic signposting is possible, with direction indications which are received on the communication device.

The present invention has various embodiments and is not limited to commercial messages. It is also possible to send direction indications to the owner of a communication device, in particular a GSM telephone, within a network with an extensive coverage, such as the usual GSM network. At a location such as an airport where a wireless network has also been set up, the owner of a communication device can be notified via WiFi or BlueTooth of the impending departure of his or her flight and can then also receive directions for guidance to the relevant gate at the airport.

Repeated emphasis has been placed in the foregoing on the initiation of the communication from the network on the basis of a position determination or detection of a communication device in or relative to a network with wide or smaller operating ranges of the network. It is however also possible for the owner of the communication device to be the one who initiates the exchange. A user or owner of the communication device can for instance send a request to be sent or guided to a determined location. The aircraft passenger can thus request directions him/herself when he or she is not (very) familiar with a particular airport). After receiving the request, the network can be adapted to send a sequence of messages to the relevant communication device from which the request has come.

Common communication devices, such as GSM telephones and PDAs and laptops with options for communicating via diverse networks, such as the GSM network, the WiFi network or BlueTooth, comprise a transmitter for emitting an identification signal, on the basis of which recognition of the presence of the communication device in a network with limited range can be detected, or on the basis of which position determination, for instance on the basis of triangulation, can be realized in a network with a greater range. If the communication device of an owner makes itself known to a network by emitting an identification signal, the network is able to detect the presence of the communication device, or even determine the location up to a certain accuracy, which corresponds to a certain extent with the above functions in for instance the GSM network in respect of emergency situations. However, the present invention is then distinguished therefrom in that no communication to another user of the network, such as an emergency service, is established, but remains limited to communication with the communication device of the owner in question in order to send a message thereto.

Apart from the possibilities of applying the present invention in extensive networks with a large range of coverage, it is also possible to apply the present invention in a network with a transmitter/receiver with a limited transmitting/receiving range in or close to only the establishment, such as a shop. It is therefore only the shoppers who intend to visit the establishment anyway who can be reached with messages, possibly of a commercial nature. The transmitter/receiver can herein be placed particularly at or close to an entrance or exit of the establishment. This does not however preclude the possibility of people passing in front of the establishment being approached with commercial messages. This may be less desirable in some applications, whereby it might conversely be advisable to place a transmitter/receiver at a greater distance from the entrance or exit, wherein the range of the transmitter/receiver then preferably corresponds to the distance from the entrance or exit.

A plurality of transmitters/receivers can also be arranged inside one establishment, for instance to enable use of a triangulation algorithm within an establishment for the purpose of determining the location of a communication device in the establishment.

A specific embodiment of a system according to the present invention will be described hereinbelow, this with reference to the single FIGURE.

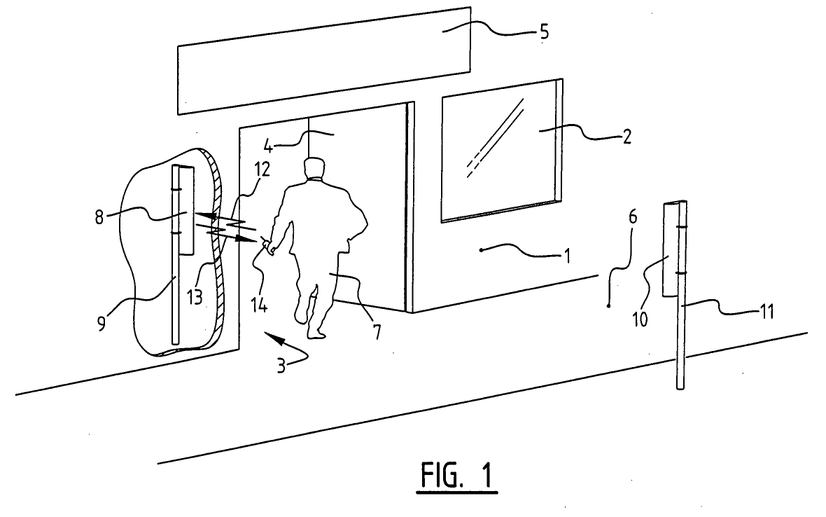

FIGURE 1 shows a shop front 1. Shop front 1 forms part of a shop as a possible embodiment of an establishment according to the present invention. Formed in front 1 is a window 2 and a door opening 3 which can be closed with at least one door 4. Arranged above the door is a shop sign 5, which can for instance be a neon advertisement.

Shop front 1 adjoins a shopping street 6 along which shoppers 7 can walk and, as desired, enter the shop of which front 1 forms part. Immediately behind the door can be arranged a transmitter/receiver 8 which preferably has a very limited range. Shoppers 7, or at least the single individual thereof shown in the FIGURE, can enter a shop through door opening 3, for instance with a mobile phone 14 in the hand. Mobile phone 14 transmits identification signals in usual manner. These can be picked up by antenna 8, which is mounted on a post 9 just behind door opening 3.

GSM receiver 8 can form part of a network, of which GSM antennas 10 on posts 11 outside the shop of shop front 1 can also form part. In the present embodiment however, it is to some extent recommended that GSM antenna 8 stands alone and functions in a network which, strictly speaking, is associated with the interior of the establishment, in particular the shop. The identification signals from a mobile phone 14 are designated with arrow 12, and signals from antenna 8 back to mobile phone 14 are designated with an arrow 13.

The operation of the system according to the present invention is now as follows.

When GSM receiver 8 detects the proximity of a GSM telephone 14 on the basis of the identification signal as according to arrow 12, GSM antenna 8 is adapted to be actuated and to send a message, in particular a commercial message, to GSM telephone 14 of shopper 7, this being indicated with arrow 13. The commercial message can contain diverse types of information, such as weekly offers, monthly offers, the location of determined products which the shopper might wish to find, etc. The wish or search for determined products can also be made known along arrow 12 to the network, of which GSM antenna 8 forms part. In an alternative embodiment the location of a person among shoppers 7 is determined or established on the basis of triangulation with a plurality of antennas, only two of which are shown in FIGURE 1. When a person among shoppers 7 enters a relevant store, specific commercial messages can be transmitted along arrow 13 to mobile phone 14 of shopper 7.

Sending commercial messages is not the only possibility. Depending on the accuracy of the position determination, it is also possible to send complete route directions or descriptions to the mobile phone of the person 7 among shoppers 7. If it is known at any random moment where the person is located, instructions can be sent relating to the route which a person 7 among shoppers 7 must walk in order to arrive at a desired product or weekly offer, etc. The same principle can be applied for a person heading to a destination, such as a gate of a departing aeroplane, at an airport or other location.

The system according to the present invention makes it possible that each recipient device can receive the transmitted messages irrespective of the platform, such as GSM, GPRS, UMTS. The connection which is made here between telephone 14 and a network with antenna 8 is to some extent related to the establishing of a mobile connection with a base station during international roaming, the use of the mobile network of a foreign operator after a border has been crossed. This comprises the steps of:
Mobile phone 14 moving away from the base station of the home operator, the operator which has the mobile subscription. At a given moment the distance is so great (the signal so weak) that the connection is broken.
After breaking the connection, mobile phone 14 listens to the so-called signalling channel in order to detect to other base stations at this location a connection can be made.
Mobile phone 14 chooses one of these base stations. Depending on the implementation of the mobile phone, this choice can be based on signal strength or on a list of preferred operators determined (and loaded into the mobile phone) by the home operator.
Mobile phone 14 registers with the selected network and a connection is established.

In a first possible embodiment according to the invention, as shown for instance in FIG. 1, a GSM connection is for instance made between a mobile phone and a transmitting station after entering the Intelligent Messaging Services (IMS) area. The steps here are:
The transmitting station transmits its identity on the GSM signalling channel in order to make the presence of these transmitting stations known to the mobile phones in the service area. The service area is adapted such that the regular GSM base stations provide no coverage in the area.
The mobile phone enters the service area and loses the connection with the regular GSM base station.
After breaking the connection the mobile phone listens to the signalling channel in order to detect to which other base stations it is possible to connect at this location.
The mobile phone opts for connection to the transmitting station (this may be the only station which can transmit on a sufficiently strong signalling channel in this area) and registers here in accordance with the standard GSM procedure.
There is a GSM connection between the transmitting station and the mobile phone. The full identity of the mobile phone is hereby known to the transmitting station.

In this embodiment the signals from the GSM operators are switched off, for instance by physical screening or interference signals. Alternatively, it is possible to have the transmitter stations form part of, or be directly connected to, a base station (for instance on the basis of picocell or femtocell technology) placed by an operator in the service area of the invention.

In a second possible embodiment according to the invention the signals transmitted by the mobile phone are however coded in order to thus find the identity of the mobile phone. The steps here are:
An active mobile phone in the service area transmits signals to a GSM base station.
The transmitter station receives these signals and reads an identity of the mobile phone therefrom. A number of possibilities can be envisaged for this purpose. The following list serves to illustrate the options which can be envisaged, not as an exhaustive list of all options:
   a. Through co-action with the operator of the GSM base stations the transmitter station has access to the cryptographic keys required to decrypt the GSM signal, whereby the transmitter station has access to all the information in the GSM signal.
   b. The base station decodes a non-encrypted part of the signal containing an identity (for instance IMEI) of the mobile phone.
Messages are sent to the mobile phone on the basis of the obtained identity. Three alternatives can be envisaged here:
   a. The transmitter station has derived the telephone number of the mobile from the signal.
   b. The transmitter station has derived an identity of the mobile phone and sends this to the operator in order to receive a/the telephone number from the operator.
   c. The transmitter station has derived an identity of the mobile phone and sends this to the operator. This identity is then used in the communication between transmitter station and the operator.
The identity of the mobile phone is now known at the transmitter station and messages can be sent by the transmitter station (if the transmitter station has found the mobile telephone number (cases a and b above), or by the operator (in all cases).

The present invention is described at length in the foregoing within the scope of a single embodiment. It will however be apparent that various additional and alternative possibilities will occur to the skilled person after examination of the foregoing. It is thus possible for mobile communications means or devices other than a GSM device to be used, for instance a PDA, a laptop, etc., and networks based on other technical principles can be applied, such as WiFi, BlueTooth, etc., can also be applied. Nor is the system according to the present invention limited to application in an establishment in the form of a shop, and application of the invention is likewise possible at any random location, such as an airport etc. It is thus found that the invention is limited solely to the subject matter and definition of the letter and/or the spirit of the appended claims, and not to the specifically shown and described embodiment. The shown components of the system are therefore also only schematic and can have other random embodiments. It is not even necessary per se for an antenna or transmitter to be arranged in a specific establishment. It is for instance possible to determine the location of a person very accurately on the basis of the network for mobile telephony, such as the GSM network. In such an embodiment the location of a person among shoppers can be determined, and commercial messages can be sent to this person, or at least equipment thereof, such as a telephone, depending on a detected position, and in particular when such a detected position is located in a specific establishment which has made provisions for the shoppers visiting the shop in question. In this context the operator of the GSM network and the owner or manager of the shop in question can enter into a joint venture.

1. System for telecommunication, comprising:
a wireless network for telecommunication with at least one transmitter/receiver, which network is provided with message facilities such as SMS and MMS and the like; and
at least one portable communication device connected to or to be connected to the network and having means for at least receiving messages, which network comprises means for determining the position of the communication device in or close to an establishment, and comprises
a transmitter for sending a message to the communication device in character with the establishment.

2. System as claimed in claim 1, wherein the message is a commercial message.

3. System as claimed in claim 2, wherein the commercial message gives an indication of offers in the establishment.

4. System as claimed in claim 1, further comprising wherein the message gives an indication of the location or direction and/or distance of goods or products in the establishment.

5. System as claimed in claim 1, further comprising wherein the communication device comprises transmitting means for sending, to or via the network, a request relating to the location of products in the establishment.

6. System as claimed in claim 1, further comprising wherein the position determination in the network is based on an identification signal from the communication device.

7. System as claimed in claim 1 further comprising, a transmitter/receiver with a limited transmitting/receiving range in or close to the establishment, such as a shop.

8. System as claimed in claim 7, wherein the transmitter/receiver is placed in or close to an entrance or exit of the establishment.

9. System as claimed in claim 1, further comprising wherein the communication device is one from the group comprising: a GSM device, a smart phone, a PDA, a communication device with wireless network function, such as WiFi, BlueTooth, etc.

10. System as claimed in claim 1, further comprising wherein the network has a range corresponding to the direct vicinity and the interior of the establishment.

11. System as claimed in claim 1, further comprising wherein the network has a considerably greater coverage than just the establishment, wherein the location of the communication device in the network can be determined with a positioning algorithm such as triangulation.
